(19) United States
(12) Patent Application Publication
(10) Pub. No.: US 2015/0141571 A1
(43) Pub. Date: May 21, 2015

(54) WATER-REPELLENT AND OIL-REPELLENT COATING, AND FORMATION METHOD THEREOF

(71) Applicant: Toyota Jidosha Kabushiki Kaisha, Toyota-shi Aichi-ken (JP)

(72) Inventors: Satoshi Takata, Toyota-shi Aichi-ken (JP); Takeshi Bessho, Toyota-shi Aichi-ken (JP)

(21) Appl. No.: 14/594,692

(22) Filed: Jan. 12, 2015

Related U.S. Application Data
(63) Continuation of application No. 13/738,392, filed on Jan. 10, 2013.

(30) Foreign Application Priority Data
Jan. 10, 2012 (JP) 2012-001943

(51) Int. Cl. C09K 3/18; B05D 5/08

(52) U.S. Cl. CPC C09K 3/18; B05D 5/08
USPC 524/588; 427/387; 427/331

(57) ABSTRACT

A water-repellent and oil-repellent coating, which can exert high water-repellency and oil-repellency not only at ordinary temperature, but also even after exposure to a high temperature and whose environmental burden is low, is formed by dehydration condensation of perfluoroaryl trisilanol (at least one fluorine atom in its perfluoroaryl group may be substituted with a trifluoromethyl group) having a molecular structure in which not only functional groups which presents a surface energy, such as a methylene group, a methylene group, an ether linkage (oxygen atom), a carbonyl group, etc., but also a difluoromethylene (—CF₂—) group have been eliminated.

### CROSS-REFERENCE TO RELATED APPLICATIONS

This application is a continuation of U.S. patent application Ser. No. 13/738,392 filed Jan. 10, 2013, which claims priority of Japanese Patent Application No. 2012-001943 filed Jan. 10, 2012.

### BACKGROUND OF THE INVENTION

1. Field of the Invention

The present invention relates to a water-repellent and oil-repellent coating, and formation method of the coating. More particularly, the present invention relates to a water-repellent and oil-repellent coating which has high heat resistance, and formation method of the coating.

2. Description of the Related Art

With improvement in living standards in these days and rising of a health consciousness, a high antifouling property is increasingly demanded in various commodities around us. Furthermore, also from a viewpoint of improvement of quality and durability in various industrial products, a very high antifouling property is increasingly demanded in products used in various uses and various environments.

Then, in the art, an attempt to form a water-repellent and an oil-repellent coating on the surface of various products which are constituted by a variety of materials and impart antifouling property to the surface of the products and thereby improve an antifouling property of the products has been studied actively. For example, as a water-repellent coating according to a conventional technology, a coating consisting of a compound containing trifluoromethyl (CF₃) group is known. As a raw material of such a compound containing a CF₃ group, fluoroalkylsilane (FAS) system compounds are used conventionally and widely used and, among them, especially, C8FAS (CF₃—(CF₂)₇—(CH₂)₂—Si) and C6FAS (CF₃—(CF₂)₅—(CH₂)₂—Si) which have a comparatively long fluoroalkyl group have been used widely.

However, since the environmental burden of C8FAS and C6FAS which have a comparatively long fluoroalkyl group is high, in light of an exaltation of environmental conservation awareness in recent years, a water-repellent coating which uses as a raw material an FAS which has a comparatively short fluoroalkyl group whose environmental burden is low has been developed. Among these, C4FAS (CF₃—(CF₂)₃—(CH₂)₂—Si) has attracted attention as an FAS which can attain a low environmental burden and a low surface energy simultaneously.

Specifically, in Patent Document 1, it has been disclosed to manufacture a water-repellent coating by hardening a hardenable (curable) composition which contains a metallic alkoxide, a colloidal silica, a silane compound which has a fluoroalkyl group (for example, C4FAS) or a silane compound which has a fluoropolyether group, and water on a transparent substrate film to form a hardened coating.

Moreover, in accordance with Patent Document 2, it has been disclosed to manufacture a water-repellent and oil-repellent member by covering the surface of a substrate with a substance which has a fluorine-containing functional group in which any or all of hydrogen atoms in its hydrocarbon group are substituted with either or both of a fluorine atom and a fluorocarbon group.

However, the substances according to a conventional technology and constituting a water-repellent and oil-repellent coating may include a methylene group, an ether linkage (oxygen atom), a carbonyl group, etc. in their molecular structure, and it is difficult to attain sufficient water-repellency and oil-repellency due to a high surface energy exhibited by these functional groups. Moreover, in a production method of a water-repellent and oil-repellent member disclosed in Patent Document 2, the above-mentioned fluorine-containing functional group is introduced by previously covering the surface of the above-mentioned substrate beforehand with a substance which has a hydrocarbon group and further carrying out a low-pressure plasma treatment in a gas atmosphere of a compound containing a fluorocarbon group. Therefore, its manufacturing process may become complicated to lead to an increase in a manufacturing cost.

On the other hand, in Patent Document 3, it has been disclosed to manufacture a highly water-repellent material by coating the surface of a substrate with the hydrolyzate of a perfluoroalkylsilane system compound represented by a general formula (F₃C)ₘ(CF₃₋ₙ)ₙSiX₄₋ₙ or (F₃C)ₙSiX₄₋ₙ (in the formula, m and n represent a whole number of 1 to 3, X represents a halogen atom or a alkoxy group with a carbon number of 5 or less) and drying the same by heating.

Since the substance which constitutes the water-repellent and oil-repellent coating according to the above conventional technology does not contain a methylene chain, an ether linkage (oxygen atom), a carbonyl group, etc. in its molecular structure, sufficient water-repellency and oil-repellency can be attained. However, since the synthesis of the perfluoroalkylsilane system compounds which have a complicated molecular structure represented by the above-mentioned general formula is not easy, such compounds are difficult to be obtained or very expensive in many cases. As a result, disposing a water-repellent and oil-repellent coating which consists of such a compound may lead to increase in manufacturing cost of target products.

Moreover, as in the art mentioned previously, from a viewpoint of improvement of quality and durability in various industrial products, a very high antifouling property is increasingly demanded in products used in various uses and various environments. Specifically, for example, in a member exposed to a very high temperature, such as a heat sink used for heat dissipation of a power device, a very high antifouling property is increasingly demanded for the purpose of preventing decrease in cooling capability resulting from an adhesion of a stain etc.

Although perfluoroalkylsilane compounds according to conventional technologies as mentioned above can form a coating which presents outstanding water-repellency performance and are also chemically stable comparatively, at a very high temperature as mentioned above, a bond between carbon and fluorine (C—F bond) in a difluoromethylene (—CF₂—) group included in a perfluoroalkyl group may be pyrolyzed and the water-repellency performance may fall as a result.

As mentioned above, in the art, there has been a continuous demand for a water-repellent and oil-repellent coating which can be formed by a concise method using a raw material which is easy to be obtained and can exert high water-repellency and oil-repellency, and whose environmental burden is low. Moreover, in the art, there has been a continuous demand for a water-repellent and oil-repellent coating which can be formed by a concise method using a raw material which is easy to be obtained and can exert high water-repellency and oil-repellency even after exposure to a high temperature, and whose environmental burden is low.

### CITATION LIST

### Patent Literature

[Patent Document 1] Japanese Patent Application Laid-Open (kokai) No. 2009-154480
[Patent Document 2] Japanese Patent Application Laid-Open (kokai) No. 2010-247333
[Patent documents 2] No. provisional-publication-of-a-patent 2010-247333 official report
[Patent Document 3] Japanese Patent Application Laid-Open (kokai) No. 07-8900

### SUMMARY OF THE INVENTION

### Problem to be Solved

As mentioned previously, in the art, there has been a continuous demand for a water-repellent and oil-repellent coating which can be formed by a concise method using a raw material which is easy to be obtained and can exert high water-repellency and oil-repellency, and whose environmental burden is low. Moreover, in the art, there has been a continuous demand for a water-repellent and oil-repellent coating which can be formed by a concise method using a raw material which is easy to be obtained and can exert high water-repellency and oil-repellency even after exposure to a high temperature, and whose environmental burden is low.

The present invention has been conceived in order to meet such a demand. Namely, the present invention has an objective to provide a water-repellent and oil-repellent coating which can be formed by a concise method using a raw material which is easy to be obtained and can exert high water-repellency and oil-repellency not only at ordinary temperature, but also even after exposure to a high temperature, and whose environmental burden is low.

### Means for Solving the Problem

The above-mentioned purpose can be achieved by;

a water-repellent and oil-repellent coating formed on a surface of a substrate,

wherein:

said coating has a siloxane skeleton,

at least one or both of a perfluoroalkylaryl group, in which all of the perfluoroalkyl group(s) is a trifluoromethyl group, and a perfluoroaryl group is bonded with a silicon atom which constitutes said siloxane skeleton, through an aromatic-carbon atom, and

a silicon atom which constitutes said siloxane skeleton is bonded with the surface of said substrate through an oxygen atom which does not constitute said siloxane skeleton.

Moreover, the above-mentioned purpose can be also achieved by;

a formation method of a water-repellent and oil-repellent coating formed on a surface of a substrate,

wherein:

said coating has a siloxane skeleton,

at least one or both of a perfluoroalkylaryl group, in which all of the perfluoroalkyl group(s) is a trifluoromethyl group, and a perfluoroaryl group is bonded with a silicon atom which constitutes said siloxane skeleton, through an aromatic-carbon atom, and

a silicon atom which constitutes said siloxane skeleton is bonded with the surface of said substrate through an oxygen atom which does not constitute said siloxane skeleton,

which includes:

hydrolyzing at least one or both of a precursor of perfluoroalkylaryl trisilanol, in which all of the perfluoroalkyl group(s) is a trifluoromethyl group, and a precursor of perfluoroaryl trisilanol,

coating a solution comprising at least one or both of perfluoroalkylaryl trisilanol and perfluoroaryl trisilanol obtained by said hydrolysis of said precursor, on the surface of said substrate, and

by a dehydration condensation reaction of said silanol, forming said siloxane skeleton, as well as bonding a silicon atom which constitutes said siloxane skeleton with the surface of said substrate through an oxygen atom which does not constitute said siloxane skeleton.

### Effect of the Invention

In accordance with the present invention, a water-repellent and oil-repellent coating which can be formed by a concise method using a raw material which is easy to be obtained and can exert high water-repellency and oil-repellency not only at ordinary temperature, but also even after exposure to a high temperature, and whose environmental burden is low, can be provided.

### BRIEF DESCRIPTION OF THE DRAWINGS

FIG. 1 is a synthesis scheme showing a formation method of a water-repellent and oil-repellent coating of Working Example 1 (WE1) according to one embodiment of the present invention.

FIG. 2 is a X-ray Photoelectron Spectroscopy (XPS) spectrum on the surfaces of a water-repellent and oil-repellent coating of Working Example 1 (WE1) according to one embodiment of the present invention and water-repellent and oil-repellent coatings of Comparative Examples 1 and 2 (CE1 and CE2) according to a conventional technology.

### DESCRIPTION OF THE PREFERRED EMBODIMENTS

As mentioned previously, one purpose of the present invention is to provide a water-repellent and oil-repellent coating which can be formed by a concise method using a raw material which is easy to be obtained and can exert high water-repellency and oil-repellency not only at ordinary temperature, but also even after exposure to a high temperature, and whose environmental burden is low.

As a result of wholehearted research for achieving the above-mentioned objective, the present inventors have found that a water-repellent and oil-repellent coating, which can exert high water-repellency and oil-repellency not only at ordinary temperature, but also even after exposure to a high temperature and whose environmental burden is low, can be formed by dehydration condensation of perfluoroaryl trisilanol (at least one fluorine atom in its perfluoroaryl group may be substituted with a trifluoromethyl group) having a molecular structure in which not only functional groups which presents a surface energy, such as a methylene group, a methylene group, an ether linkage (oxygen atom), a carbonyl group, etc., but also a difluoromethylene (—CF₂—) group have been eliminated, and have come to conceive the present invention.

Namely, the first embodiment of the present invention is,

a water-repellent and oil-repellent coating formed on a surface of a substrate,

wherein:

said coating has a siloxane skeleton,

at least one or both of a perfluoroalkylaryl group, in which all of the perfluoroalkyl group(s) is a trifluoromethyl group, and a perfluoroaryl group is bonded with a silicon atom which constitutes said siloxane skeleton, through an aromatic-carbon atom, and

a silicon atom which constitutes said siloxane skeleton is bonded with the surface of said substrate through an oxygen atom which does not constitute said siloxane skeleton.

As mentioned above, a water-repellent and oil-repellent coating according to the present embodiment has a siloxane skeleton. As well-known by the person skilled in the art, a siloxane skeleton is a principal chain constituted by repetition of a siloxane bond (Si—O—Si). Moreover, in a water-repellent and oil-repellent coating according to the present embodiment, as mentioned above, at least one or both of a perfluoroalkylaryl group, in which all of the perfluoroalkyl group(s) is a trifluoromethyl group, and a perfluoroaryl group is bonded with a silicon atom which constitutes the siloxane skeleton, through an aromatic-carbon atom.

In other words, in a water-repellent and oil-repellent coating according to the present embodiment, at least one or both of a perfluoroalkylaryl group, in which all of the perfluoroalkyl group(s) is a trifluoromethyl group, and a perfluoroaryl group is directly bonded with a silicon atom which constitutes the siloxane skeleton, not through, for example, a methylene group or ethylene group, or a difluoromethylene group or a tetrafluoroethylene group, etc., but through an aromatic-carbon atom included in an aryl group constituting a perfluoroalkylaryl group and/or a perfluoroaryl group. Therefore, there is no possibility that it may become difficult to attain sufficient water-repellency and an oil-repellency due to a high surface energy presented by a methylene group as in the case of a substance which constitutes a water-repellent and oil-repellent coating according to a conventional technology, such as the above-mentioned FAS system compounds etc.

Herein, surface energies on the surface of products, on whose surface a trifluoromethyl end group, a difluoromethyl end group, a difluoromethylene chain, or a methylene chain is exposed, are listed in the following Table 1. As shown in Table 1, a trifluoromethyl end group presents a very low surface energy on the surface of a product. Although a difluoromethyl end group corresponds to a group obtained by substituting one of three fluorine atoms in a trifluoromethyl end group with a hydrogen atom, it largely raises a surface energy. Moreover, although a difluoromethylene chain is not an end group and corresponds to a group obtained by substituting one of three fluorine atoms in a trifluoromethyl end group with, for example, an adjacent carbon atom, it presents a surface energy still higher than a difluoromethyl end group. Furthermore, as for a methylene chain, it presents as very high surface energy as several times higher than that of a trifluoromethyl end group. Thus, depending on the number of fluorine atoms bonded with one carbon atom and whether the carbon atom constitutes a terminal group or not, the surface energy presented by a functional group which the carbon atom constitutes changes largely. As a result, the water-repellency and oil-repellency of the surface on which such a functional group s exposed also changes largely.

TABLE 1

| Functional Group on Surface of Product | Surface Energy [mJ/m²] |
|---|---|
| —CF₃ End Group | 6 |
| —CF₂H End Group | 15 |
| —CF₂— Chain | 18 |
| —CH₂— Chain | 31 |

In addition, in the case where the aryl group which is bonded with a silicon atom which constitutes a siloxane skeleton is a perfluoroalkylaryl group, as mentioned above, all the perfluoroalkyl groups which constitute the perfluoroalkylaryl group are trifluoromethyl groups. A trifluoromethyl group presents a lower surface energy as compared with a difluoromethylene group which is a main structure which presents water-repellency and oil-repellency in a substance which constitutes a water-repellent and oil-repellent coating according to a conventional technology, such as the above-mentioned FAS system compounds. Also from this aspect, in a water-repellent and oil-repellent coating according to the present embodiment, higher water-repellency and oil-repellency over and above conventional technologies can be attained.

Furthermore, in a water-repellent and oil-repellent coating according to the present embodiment, a fluorine atom is bonded with all (except for a carbon atom with which a trifluoromethyl group is bonded, as mentioned above) carbon atoms other than a carbon atom which is directly bonded with a silicon atom which constitutes a siloxane skeleton among aromatic-carbon atoms included in an aryl group. In such a bond between an aromatic carbon and a fluorine atom, localization of an electron cloud in a bond between a carbon atom and a fluorine atom (C—F bond) is smaller, as compared with a bond between an aliphatic carbon atom and a fluorine atom in a difluoromethylene group which is a main structure which presents water-repellency and oil-repellency in a substance which constitutes a water-repellent and oil-repellent coating according to a conventional technology, such as the above-mentioned FAS system compounds. Therefore, a bond between an aromatic carbon atom and a fluorine atom in a water-repellent and oil-repellent coating according to the present embodiment is chemically more stable as compared with a bond between an aliphatic carbon atom and a fluorine atom in a water-repellent and oil-repellent coating according to a conventional technology. As a result, as for the bond between an aromatic carbon atom and a fluorine atom in a water-repellent and oil-repellent coating according to the present embodiment, a bond between carbon and fluorine (C—F bond) is less likely to be pyrolyzed to lower water-repellency and oil-repellency performance, even in a use associated with exposure to a very high temperature (for example, an antifouling coating for a member, such as a heat sink used for heat dissipation of a power device, etc.). Namely, a water-repellent and the oil-repellent coating according to the present embodiment can exert higher heat resistance as compared with a water-repellent and oil-repellent coating according to a conventional technology, which comprises a difluoromethylene group.

In addition to the above, the above-mentioned substance which constitutes a water-repellent and oil-repellent coating according to the present embodiment has a small environmental burden as compared with perfluoro compounds which have a long-chain perfluoroalkyl group in their molecular structure. Therefore, it can be said that a water-repellent and oil-repellent coating according to the present embodiment is a more desirable water-repellent and oil-repellent coating also from a viewpoint of an environmental protection.

On the other hand, a silicon atom which constitutes a siloxane skeleton is bonded with the surface of a substrate through an oxygen atom which does not constitute a siloxane skeleton (—Si—O— bond). Since the bond is very stable, a water-repellent and oil-repellent coating according to the present embodiment can be certainly fixed on the surface of a substrate. As material of a substrate, although not particularly limited, for example, metals, such as stainless steel, aluminum etc., and glass, etc. can be exemplified.

As mentioned above, in accordance with a water-repellent and the oil-repellent coating according to the present embodiment, a water-repellent and oil-repellent coating which can exert high water-repellency and oil-repellency not only at ordinary temperature, but also even after exposure to a high temperature, and whose environmental burden is low, can be provided.

In addition, in a water-repellent and oil-repellent coating according to the present embodiment, as mentioned above, at least one or both of a perfluoroalkylaryl group, in which all of the perfluoroalkyl group(s) is a trifluoromethyl group, and a perfluoroaryl group is bonded with a silicon atom which constitutes a siloxane skeleton, through an aromatic-carbon atom. The perfluoroalkylaryl group may be any kind of perfluoroalkylaryl group, as long as all of the perfluoroalkyl group(s) which constitutes the perfluoroalkylaryl group is a trifluoromethyl group.

As specific examples of the above-mentioned perfluoroalkylaryl group, for example, 4-trifluoromethyl-2,3,5,6-tetrafluorophenyl group, 3,5-di(trifluoromethyl)-2,4,6-trifluorophenyl group, 2,4,6-tri(trifluoromethyl)-3,5-difluorophenyl group, etc. can be exemplified. Moreover, a basic skeleton of the perfluoroaryl group which constitutes the above-mentioned perfluoroalkylaryl group may be a benzene ring like the above-mentioned specific example, or may be a naphthalene ring. Among these, 4-trifluoromethyl-2,3,5,6-tetrafluorophenyl group is especially desirable, since its raw material which has a corresponding perfluoroalkyl group is easily available.

Moreover, the above-mentioned perfluoroaryl group may not be limited to a specific compound, and may be, for example, a perfluorophenyl group, a perfluoronaphthyl group, etc. Among these, a perfluorophenyl group is especially desirable, since its raw material which has a corresponding perfluoro group is easily available.

Therefore, the second embodiment of the present invention is,

the water-repellent and oil-repellent coating according to said first embodiment of the present invention, wherein:

said perfluoroalkylaryl group is a 4-trifluoromethyl-2,3,5,6-tetrafluorophenyl group, and

said perfluoroaryl group is a perfluorophenyl group.

As mentioned above, in a water-repellent and oil-repellent coating according to the present embodiment, a perfluoroalkyl aryl group which is bonded with a silicon atom which constitutes a siloxane skeleton is a 4-trifluoromethyl-2,3,5,6-tetrafluorophenyl group, and a perfluoroaryl group which is bonded with a silicon atom which constitutes a siloxane skeleton is a perfluorophenyl group. Precursors which have such molecular structures (for example, 4-trifluoromethyl-2,3,5,6-tetrafluorophenyl-trialkoxysilane, 4-trifluoromethyl-2,3,5,6-tetrafluorophenylsilane trihalide, and 4-trifluoromethyl-2,3,5,6-tetrafluorophenyl-triaminosilane, etc., and perfluorophenyl-trialkoxysilane, perfluorophenyl-silane trihalide, and perfluorophenyl-triaminosilane, etc.) are comparatively easily available as mentioned above. Therefore, a water-repellent and the oil-repellent coating according to the present embodiment can form a water-repellent and an oil-repellent coating at comparatively cheap manufacturing cost.

By the way, as mentioned above, the present invention relates not only to a water-repellent and an oil-repellent coating, but also to a formation method of the coating. Namely, a method for forming water-repellent and oil-repellent coatings according to various embodiments including some above-mentioned embodiments is also included in the scope of the present invention. Accordingly, although some embodiments of a formation method of a water-repellent and oil-repellent coating according to the present invention will be explained below, as for the content which overlaps with the explanation about the water-repellent and oil-repellent coatings according to some above-mentioned embodiments, they will not be explained anew below, but omitted.

First, the third embodiment of the present invention is,

a formation method of a water-repellent and oil-repellent coating formed on a surface of a substrate,

wherein:

said coating has a siloxane skeleton,

at least one or both of a perfluoroalkylaryl group, in which all of the perfluoroalkyl group(s) is a trifluoromethyl group, and a perfluoroaryl group is bonded with a silicon atom which constitutes said siloxane skeleton, through an aromatic-carbon atom, and a silicon atom which constitutes said siloxane skeleton is bonded with the surface of said substrate through an oxygen atom which does not constitute said siloxane skeleton,

which includes:

hydrolyzing at least one or both of a precursor of perfluoroalkylaryl trisilanol, in which all of the perfluoroalkyl group(s) is a trifluoromethyl group, and a precursor of perfluoroaryl trisilanol,

coating a solution comprising at least one or both of perfluoroalkylaryl trisilanol and perfluoroaryl trisilanol obtained by said hydrolysis of said precursor, on the surface of said substrate, and

by a dehydration condensation reaction of said silanol, forming said siloxane skeleton, as well as bonding a silicon atom which constitutes said siloxane skeleton with the surface of said substrate through an oxygen atom which does not constitute said siloxane skeleton.

As mentioned above, a water-repellent and oil-repellent coating which is formed by a formation method of a water-repellent and oil-repellent coating according to the present embodiment, has a siloxane skeleton, and at least one or both of a perfluoroalkylaryl group, in which all of the perfluoroalkyl group(s) is a trifluoromethyl group, and a perfluoroaryl group is bonded with a silicon atom which constitutes said siloxane skeleton, through an aromatic-carbon atom, and a silicon atom which constitutes said siloxane skeleton is bonded with the surface of said substrate through an oxygen atom which does not constitute said siloxane skeleton. As for a configuration of such a water-repellent and oil-repellent coating, since it has been already mentioned in the explanation about a water-repellent and oil-repellent coating according to the first embodiment of the present invention, it will not be explained anew here.

In a formation method of a water-repellent and oil-repellent coating according to the present embodiment, as mentioned above,

at least one or both of a precursor of perfluoroalkylaryl trisilanol, in which all of the perfluoroalkyl group(s) is a trifluoromethyl group, and a precursor of perfluoroaryl trisilanol is hydrolyzed,

a solution comprising at least one or both of perfluoroalkylaryl trisilanol and perfluoroaryl trisilanol, which is obtained by said hydrolysis of said precursor, is coated on the surface of said substrate, and

by a dehydration condensation reaction of said silanol, said siloxane skeleton is formed, as well as a silicon atom which constitutes said siloxane skeleton is bonded with the surface of said substrate through an oxygen atom which does not constitute said siloxane skeleton.

Hydrolysis of a precursor of perfluoroalkylaryl trisilanol, in which all of the perfluoroalkyl group(s) is a trifluoromethyl group, and a precursor of perfluoroaryl trisilanol can be carried out by applying, for example, a method used for hydrolysis of a precursor of organosilanol in the art. Specifically, hydrolysis of the above-mentioned precursors can be performed by, for example, hydrolysis in which an acid is used as a catalyst, hydrolysis in which a base is used as a catalyst, etc. Moreover, a precursor of perfluoroalkylaryl trisilanol, in which all of the perfluoroalkyl group(s) is a trifluoromethyl group, and a precursor of perfluoroaryl trisilanol may not be particularly limited as long as a trisilanol corresponding to each of them can be produced by hydrolysis. Specific examples of these precursors will be mentioned later in detail.

Next, in a formation method of a water-repellent and oil-repellent coating according to the present embodiment, a solution comprising at least one or both of perfluoroalkylaryl trisilanol and perfluoroaryl trisilanol, which is obtained by said hydrolysis of the above-mentioned precursor, is coated on the surface of a substrate. Solvent of the above-mentioned solution is not particularly limited as long as it can dissolve the above-mentioned silanol successfully. In addition, given that the above-mentioned silanol is made to form a coating after a coating process, it is more desirable that solvent of the above-mentioned solution can be easily removed from the above-mentioned solution. Furthermore, it is much more desirable that the above-mentioned solvent has a low environmental burden. From such a viewpoint, as the above-mentioned solvent, for example, alcohols, such as an ethanol, can be chosen.

Moreover, as mentioned above, as material of a substrate, although not particularly limited, for example, metals, such as stainless steel, aluminum etc., and glass, etc. can be exemplified. Furthermore, a method for applying the above-mentioned solution on the surface of a substrate is not limited to a specific method, either, and can be suitably chosen from various coating methods well-known in the art, depending on characteristics of the above-mentioned solution and a substrate, design specification and ambient environment of processing equipment used in a coating process, etc. Specifically, as a method for coating the above-mentioned solution, for example, a dip coating method (dipping method), a spray coating method, a spin coating method, etc. can be exemplified.

Subsequently, in a formation method of a water-repellent and oil-repellent coating according to the present embodiment, by a dehydration condensation reaction of silanol, a siloxane skeleton is formed, as well as a silicon atom which constitutes a siloxane skeleton is bonded with the surface of a substrate through an oxygen atom which does not constitute a siloxane skeleton. A dehydration condensation reaction of silanol can be carried out by applying, for example, a method used for dehydration condensation of organosilanol in the art. Specifically, dehydration condensation of the above-mentioned silanols can be performed by, for example, dehydration condensation in which an acid is used as a catalyst, dehydration condensation in which a base is used as a catalyst, dehydration condensation which proceeds with heat, etc.

By the above-mentioned dehydration condensation reaction of silanol, a siloxane skeleton is formed. As a result, a strong coating (film) which has a siloxane skeleton as a host framework (main framework) and a side chain which consists of at least one or both of a perfluoroalkylaryl group, in which all of the perfluoroalkyl group(s) is a trifluoromethyl group, and a perfluoroaryl group and is bonded with a silicon atom which constitutes the siloxane skeleton through an aromatic-carbon atom. Simultaneously, a silicon atom which constitutes a siloxane skeleton is strongly bonded with the surface of a substrate through an oxygen atom which does not constitute a siloxane skeleton

As mentioned above, in accordance with a formation method of a water-repellent and oil-repellent coating according to the present embodiment,

a water-repellent and oil-repellent coating,

which has a siloxane skeleton, and

wherein;

at least one or both of a perfluoroalkylaryl group, in which all of the perfluoroalkyl group(s) is a trifluoromethyl group, and a perfluoroaryl group is bonded with a silicon atom which constitutes said siloxane skeleton, through an aromatic-carbon atom, and

a silicon atom which constitutes said siloxane skeleton is bonded with the surface of said substrate through an oxygen atom which does not constitute said siloxane skeleton, can be formed.

In the above-mentioned water-repellent and oil-repellent coating, at least one or both of a perfluoroalkylaryl group, in which all of the perfluoroalkyl group(s) is a trifluoromethyl group, and a perfluoroaryl group is directly bonded with a silicon atom which constitutes the siloxane skeleton, not through, for example, a methylene group or ethylene group, or a difluoromethylene group or a tetrafluoroethylene group, etc., but through an aromatic-carbon atom included in an aryl group constituting a perfluoroalkylaryl group and/or a perfluoroaryl group. Therefore, the above-mentioned water-repellent and oil-repellent coating can exert higher water-repellency and an oil-repellency as compared with a water-repellent and oil-repellent coating according to a conventional technology, such as the previously-mentioned FAS system compounds etc.

Moreover, as mentioned previously, in the case where the aryl group which is bonded with a silicon atom which constitutes a siloxane skeleton is a perfluoroalkylaryl group, all the perfluoroalkyl groups which constitute the perfluoroalkylaryl group are trifluoromethyl groups. A trifluoromethyl group presents a lower surface energy as compared with a difluoromethylene group which is a main structure which presents water-repellency and oil-repellency in a substance which constitutes a water-repellent and oil-repellent coating according to a conventional technology, such as the previously-mentioned FAS system compounds. Also from this aspect, in the above-mentioned water-repellent and oil-repellent coating, higher water-repellency and oil-repellency over and above conventional technologies can be attained.

Furthermore, in the above-mentioned water-repellent and oil-repellent coating, a fluorine atom is bonded with all (except for a carbon atom with which a trifluoromethyl group is bonded, as mentioned above) carbon atoms other than a carbon atom which is directly bonded with a silicon atom which constitutes a siloxane skeleton among aromatic-carbon atoms included in an aryl group. As mentioned previously, such a bond between an aromatic carbon and a fluorine atom has smaller localization of an electron cloud in a bond between a carbon atom and a fluorine atom (C—F bond) and chemically more stable, as compared with a bond between an aliphatic carbon atom and a fluorine atom. As a result, a bond between an aromatic carbon atom and a fluorine atom in the above-mentioned water-repellent and oil-repellent coating is less likely to cause decrease in lower water-repellency and oil-repellency performance due to pyrolysis thereof, even in a use associated with exposure to a very high temperature (for example, an antifouling coating for a member, such as a heat sink used for heat dissipation of a power device, etc.) as mentioned previously. Namely, the above-mentioned water-repellent and the oil-repellent coating can exert higher heat resistance as compared with a water-repellent and oil-repellent coating according to a conventional technology, which comprises a difluoromethylene group.

In addition, the above-mentioned substance which constitutes the above-mentioned water-repellent and oil-repellent coating has a small environmental burden as compared with perfluoro compounds which have a long-chain perfluoroalkyl group in their molecular structure. Therefore, it can be said that the above-mentioned water-repellent and oil-repellent coating is a more desirable water-repellent and oil-repellent coating also from a viewpoint of an environmental protection.

As mentioned above, in accordance with a formation method of a water-repellent and the oil-repellent coating according to the present embodiment, a water-repellent and oil-repellent coating which can exert high water-repellency and oil-repellency not only at ordinary temperature, but also even after exposure to a high temperature, and whose environmental burden is low, can be provided.

By the way, as mentioned previously, a precursor of perfluoroalkylaryl trisilanol, in which all of the perfluoroalkyl group(s) is a trifluoromethyl group, and a precursor of perfluoroaryl trisilanol may not be particularly limited as long as a trisilanol corresponding to each of them can be produced by hydrolysis. As such precursors, trialkoxysilane, silane trihalide, and triaminosilane, which have a corresponding perfluoroalkylaryl group, as well as trialkoxysilane, silane trihalide, and triaminosilane, which have a corresponding perfluoroaryl group, can be exemplified.

Namely, the fourth embodiment of the present invention is,

the formation method of a water-repellent and oil-repellent coating according to said third embodiment of the present invention, wherein:

said precursor of perfluoroalkylaryl trisilanol, in which all of the perfluoroalkyl group(s) is a trifluoromethyl group, comprises at least one or more of perfluoroalkylaryl-trialkoxysilane in which all of the perfluoroalkyl group(s) is a trifluoromethyl group, perfluoroalkylaryl-silane trihalide in which all of the perfluoroalkyl group(s) is a trifluoromethyl group, and perfluoroalkylaryl-triaminosilane in which all of the perfluoroalkyl group(s) is a trifluoromethyl group, and

said precursor of perfluoroaryl trisilanol comprises at least one or more of perfluoroaryl-trialkoxysilane, perfluoroaryl-silane trihalide, and perfluoroaryl-triaminosilane.

As mentioned above, in a formation method of a water-repellent and oil-repellent coating according to the present embodiment, the precursor of perfluoroalkylaryl trisilanol, in which all of the perfluoroalkyl group(s) is a trifluoromethyl group, comprises at least one or more of perfluoroalkylaryl-trialkoxysilane in which all of the perfluoroalkyl group(s) is a trifluoromethyl group, perfluoroalkylaryl-silane trihalide in which all of the perfluoroalkyl group(s) is a trifluoromethyl group, and perfluoroalkylaryl-triaminosilane in which all of the perfluoroalkyl group(s) is a trifluoromethyl group, and the precursor of perfluoroaryl trisilanol comprises at least one or more of perfluoroaryl-trialkoxysilane, perfluoroaryl-silane trihalide, and perfluoroaryl-triaminosilane. Namely, as the precursor of perfluoroalkylaryl trisilanol, one of perfluoroalkylaryl-trialkoxysilane in which all of the perfluoroalkyl group(s) is a trifluoromethyl group, perfluoroalkylaryl-silane trihalide in which all of the perfluoroalkyl group(s) is a trifluoromethyl group, and perfluoroalkylaryl-triaminosilane in which all of the perfluoroalkyl group(s) is a trifluoromethyl group can be chosen. Alternatively, the precursor of perfluoroalkylaryl trisilanol may be a combination of any two or more of these trialkoxysilanes, silane trihalides, and triaminosilanes.

On the other hand, in a formation method of a water-repellent and oil-repellent coating according to the present embodiment, the precursor of perfluoroaryl trisilanol comprises at least one or more of perfluoroaryl-trialkoxysilane, perfluoroaryl-silane trihalide, and perfluoroaryl-triaminosilane. Namely, as the precursor of perfluoroaryl trisilanol, one of perfluoroaryl-trialkoxysilane, perfluoroaryl-silane trihalide, and perfluoroaryl-triaminosilane can be chosen. Alternatively, the precursor of perfluoroaryl trisilanol may be a combination of any two or more of these trialkoxysilanes, silane trihalides, and triaminosilanes.

In addition, among trialkoxysilanes, silane trihalides, and triaminosilanes as the precursors, trialkoxysilanes are especially desirable. This is because trialkoxysilanes produce alcohol as by-product resulting from the above-mentioned hydrolysis reaction whereas silane trihalides and triaminosilanes produce hydrogen halide and amine respectively, meanwhile alcohol has a low environmental burden and is low and can be easily handled as compared with hydrogen halide and amine.

By the way, as mentioned previously, in a water-repellent and oil-repellent coating formed by a formation method of a water-repellent and oil-repellent coating according to the present invention, at least one or both of a perfluoroalkylaryl group, in which all of the perfluoroalkyl group(s) is a trifluoromethyl group, and a perfluoroaryl group is bonded with a silicon atom which constitutes a siloxane skeleton, through an aromatic-carbon atom. The perfluoroalkylaryl group may be any kind of perfluoroalkylaryl group, as long as all of the perfluoroalkyl group(s) which constitutes the perfluoroalkylaryl group is a trifluoromethyl group.

As specific examples of the above-mentioned perfluoroalkylaryl group, for example, 4-trifluoromethyl-2,3,5,6-tetrafluorophenyl group, 3,5-di(trifluoromethyl)-2,4,6-trifluorophenyl group, 2,4,6-tri(trifluoromethyl)-3,5-difluorophenyl group, etc. can be exemplified. Moreover, a basic skeleton of the perfluoroaryl group which constitutes the above-mentioned perfluoroalkylaryl group may be a benzene ring like the above-mentioned specific example, or may be a naphthalene ring. Among these, 4-trifluoromethyl-2,3,5,6-tetrafluorophenyl group is especially desirable, since its raw material which has a corresponding perfluoroalkyl group is easily available.

Moreover, the above-mentioned perfluoroaryl group may not be limited to a specific compound, and may be, for example, a perfluorophenyl group, a perfluoronaphthyl group, etc. Among these, a perfluorophenyl group is especially desirable, since its raw material which has a corresponding perfluoro group is easily available.

Therefore, the fifth embodiment of the present invention is,

the formation method of a water-repellent and oil-repellent coating according to any one of said third or fourth embodiment of the present invention, wherein:

said perfluoroalkylaryl group is a 4-trifluoromethyl-2,3,5,6-tetrafluorophenyl group, and

said perfluoroaryl group is a perfluorophenyl group.

As mentioned above, in a water-repellent and oil-repellent coating formed by a formation method of a water-repellent and oil-repellent coating according to the present embodiment, a perfluoroalkyl aryl group which is bonded with a silicon atom which constitutes a siloxane skeleton is a 4-trifluoromethyl-2,3,5,6-tetrafluorophenyl group, and a perfluoroaryl group which is bonded with a silicon atom which constitutes a siloxane skeleton is a perfluorophenyl group. Precursors which have such molecular structures (for example, 4-trifluoromethyl-2,3,5,6-tetrafluorophenyl-trialkoxysilane, 4-trifluoromethyl-2,3,5,6-tetrafluorophenylsilane trihalide, and 4-trifluoromethyl-2,3,5,6-tetrafluorophenyl-triaminosilane, etc., and perfluorophenyl-trialkoxysilane, perfluorophenyl-silane trihalide, and perfluorophenyl-triaminosilane, etc.) are comparatively easily available as mentioned previously. Therefore, in accordance with a formation method of a water-repellent and oil-repellent coating according to the present embodiment, a water-repellent and an oil-repellent coating can be formed at comparatively cheap manufacturing cost.

In addition, as mentioned previously, among trialkoxysilanes, silane trihalides, and triaminosilanes as the above-mentioned precursors, trialkoxysilanes are especially desirable. Namely, as the above-mentioned precursors, 4-trifluoromethyl-2,3,5,6-tetrafluorophenyl-trialkoxysilane and perfluorophenyl-trialkoxysilane are especially desirable. Specifically, as the above-mentioned precursors, 4-trifluoromethyl-2,3,5,6-tetrafluorophenyl-trialkoxysilane and perfluorophenyl-trialkoxysilane can be used.

By the way, as mentioned previously, dehydration condensation of the above-mentioned silanols can be performed by, for example, dehydration condensation in which an acid is used as a catalyst, dehydration condensation in which a base is used as a catalyst, dehydration condensation which proceeds with heat, etc. Among these, dehydration condensation which proceeds with heat does not require addition of further substance unlike dehydration condensation in which an acid or base is used as a catalyst and therefore it is more desirable from viewpoints of, for example, resource saving, simplification of a manufacturing process, and a manufacturing cost reduction, etc.

Therefore, the sixth embodiment of the present invention is,

the formation method of a water-repellent and oil-repellent coating according to any one of said third to fifth embodiments of the present invention, wherein:

said dehydration condensation reaction of said silanol is initiated with heating.

As mentioned above, in a formation method of a water-repellent and oil-repellent coating according to the present embodiment, said dehydration condensation reaction of said silanol is initiated with heating, but without adding an acid catalyst or a base catalyst, and therefore it is more desirable also from viewpoints of, for example, resource saving, simplification of a manufacturing process, and a manufacturing cost reduction, etc.

Hereafter, referring to an accompanying drawing etc., some embodiments of the present invention will be explained. However, the explanation which will be described below is provided only for the purpose of exemplification, and the scope of the present invention should not be interpreted as to be limited to the following explanation.

### Example

### 1. Evaluation on Water-Repellency and Oil-Repellency of Water-Repellent and Oil-Repellent Coating According to One Embodiment of the Present Invention

In the present example, water-repellency and oil-repellency of a water-repellent and oil-repellent coating according to one embodiment of the present invention was evaluated comparing with comparative examples according to a conventional technology. The details of the present example will be mentioned below.

### (1) Preparation of Samples for Evaluation

As substrates, stainless steel plate, aluminum plate, and glass plate were adopted and preliminarily washed by ultrasonic cleaning before forming a water-repellent and an oil-repellent coating thereon. Various samples for evaluation were prepared by respectively forming various water-repellent and oil-repellent coatings of Working Example 1 (WE1) according to one embodiment of the present invention as well as Comparative Examples 1 and 2 (CE1 and CE2) according to conventional technologies. The details of preparation of each sample for evaluation will be explained below. In addition, in the present example, coated film was formed by a dip coating method (dipping method).

First, preparation of a sample for evaluation according to Working Example 1 (WE1) will be explained. 24 g of 4-perfluorotolyl-triethoxysilane (4-trifluoromethyl-2,3,5, 6-tetrafluorophenyl-triethoxysilane), 17 g of hydrochloric-acid aqueous solution [0.05 N] and a 39 g of ethanol were mixed and agitated to obtain a solution containing 4-perfluorotolyl-trisilanol (4-trifluoromethyl-2,3,5,6-tetrafluorophenyl-trisilanol). Into the solution, various above-mentioned substrates were immersed and pulled up to form a coated film consisting of the solution on the surface of various substrates, and heat-treated at 200° C. for 30 minutes to form a coating according to Working Example 1 (WE1).

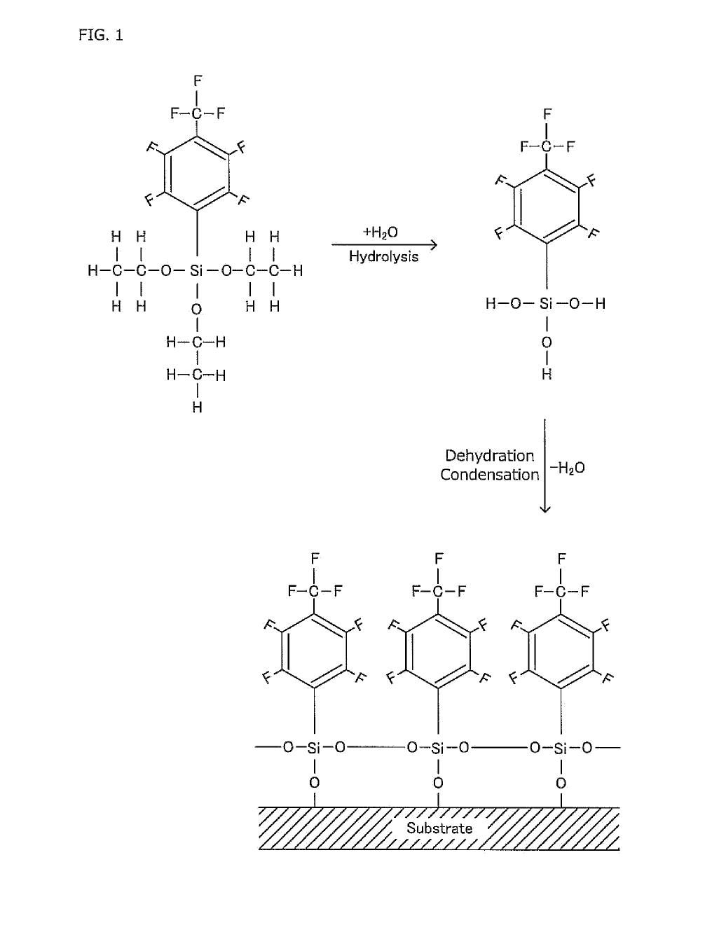

In addition, a flow of synthesis of 4-perfluorotolyl-trisilanol (4-trifluoromethyl-2,3, 5,6-tetrafluorophenyl-trisilanol) by hydrolysis of the above-mentioned 4-perfluorotolyl-triethoxysilane (4-trifluoromethyl-2,3,5,6-tetra-fluorophenyl-triethoxysilane), and formation of coated film by dehydration condensation of 4-perfluorotolyl-trisilanol (4-trifluoromethyl-2, 3,5,6-tetrafluorophenyl-trisilanol) is shown in FIG. 1. As mentioned previously, FIG. 1 is a synthesis scheme showing a formation method of a water-repellent and oil-repellent coating of Working Example 1 (WE1) according to one embodiment of the present invention.

Next, preparation of a sample for evaluation according to Comparative Example 1 (CE1) will be explained. 102 g of nonafluorohexyl-trimethoxysilane (2-(perfluorobutyl)-ethyl-trimethoxysilane), 96.1 g of tetraethoxysilane, and 18.5 g hydrochloric-acid aqueous solution [0.1N] were mixed and agitated to obtain a solution containing nonafluorohexyl-trisilanol (2-(perfluorobutyl)-ethyl-trisilanol). Into the solution, various above-mentioned substrates were immersed and pulled up to form a coated film consisting of the solution on the surface of various substrates, and heat-treated at 80° C. for 5 minutes to form a coating according to Comparative Example 1 (CE1). Namely, the substance which constitutes the coating according to Comparative Example 1 (CE1) derives from C4FAS which is a fluoroalkylsilane (FAS) system compound according to a conventional technology.

Furthermore, preparation of a sample for evaluation according to Comparative Example 2 (CE2) will be explained. 2 g of heptadecafluorodecyl-triethoxysilane (2-(perfluorooctyl)-ethyl-triethoxysilane), 50 g of isopropyl alcohol, and 2 g of 60% nitric acid were mixed and agitated to obtain a solution containing heptadecafluorodecyl-trisilanol (2-(perfluorooctyl)-ethyl-trisilanol). Into the solution, various above-mentioned substrates were immersed and pulled up to form a coated film consisting of the solution on the surface of various substrates, and heat-treated at 140° C. for 20 minutes to form a coating according to Comparative Example 2 (CE2). Namely, the substance which constitutes the coating according to Comparative Example 2 (CE2) derives from C8FAS which is a fluoroalkylsilane (FAS) system compound according to a conventional technology.

### (2) Evaluation on Water-Repellency and Oil-Repellency of Samples for Evaluation

The water-repellency and oil-repellency of the coating formed on the surface of the various substrates of the various samples for evaluation according to Working Example 1 (WE1) and Comparative Examples 1 and 2 (CE1 and CE2) which were prepared as mentioned above were evaluated. Specifically, the contact angles to water and oil on the surface of the coating formed on the surface of the various substrates of the various samples for evaluation were measured. In addition, in the present example, hexadecane was adopted as oil.

In all the samples for evaluation according to Working Example 1 (WE1) and Comparative Examples 1 and 2 (CE1 and CE2), no difference in the contact angles due to the difference in the materials of the substrates (namely, stainless steel plate, aluminum plate, and glass plate) was observed. From this, it can be considered that uniform continuous coating was formed in all the samples for evaluation according to Working Example 1 (WE1) and Comparative Examples 1 and 2 (CE1 and CE2). The measurement results of the contact angles for the various samples for evaluation according to Working Example 1 (WE1) and Comparative Examples 1 and 2 (CE1 and CE2) are listed in the following Table 2.

TABLE 2

| | Side Chain on | Contact Angle | Contact Angle |
|---|---|---|---|
| | Siloxane Skeleton | to Water [°] | to Oil [°] |
| WE1 | CF₃—C₆F₄— | 127 | 79 |
| CE1 | CF₃—(CF₂)₃—(CH₂)₂— | 109 | 63 |
| CE2 | CF₃—(CF₂)₇—(CH₂)₂— | 114 | 68 |

As apparent from the evaluation results shown in Table 2, Working Example 1 (WE1) according to one embodiment of the present invention presented larger contact angles to both of water and oil, as compared with Comparative Examples 1 and 2 (CE1 and CE2) according to a conventional technology. Namely, it has been confirmed that the coating of Working Example 1 (WE1) according to one embodiment of the present invention has higher water-repellency and oil-repellency, as compared with the coatings of Comparative Examples 1 and 2 (CE1 and CE2) according to a conventional technology.

As the reason why the coating of Working Example 1 (WE1) according to one embodiment of the present invention presented higher water-repellency and oil-repellency than the coatings of Comparative Examples 1 and 2 (CE1 and CE2) according to a conventional technology as mentioned above, it can be given that, in the coatings according to Comparative Examples 1 and 2 (CE1 and CE2), the side chain on the siloxane skeleton includes a methylene (—CH₂—) group and a difluoromethylene (—CF₂—) group constituting a factor for presenting relatively high surface energy, whereas, in the coating according to Working Example 1 (WE1), the side chain on the siloxane skeleton does not include such a group presenting relatively high surface energy, but includes only a trifluoromethyl (—CH₃) group and a fluorine atom bonded with an aromatic carbon (CF) constituting a factor for presenting relatively low surface energy.

### (3) Analysis on Surface of Samples for Evaluation

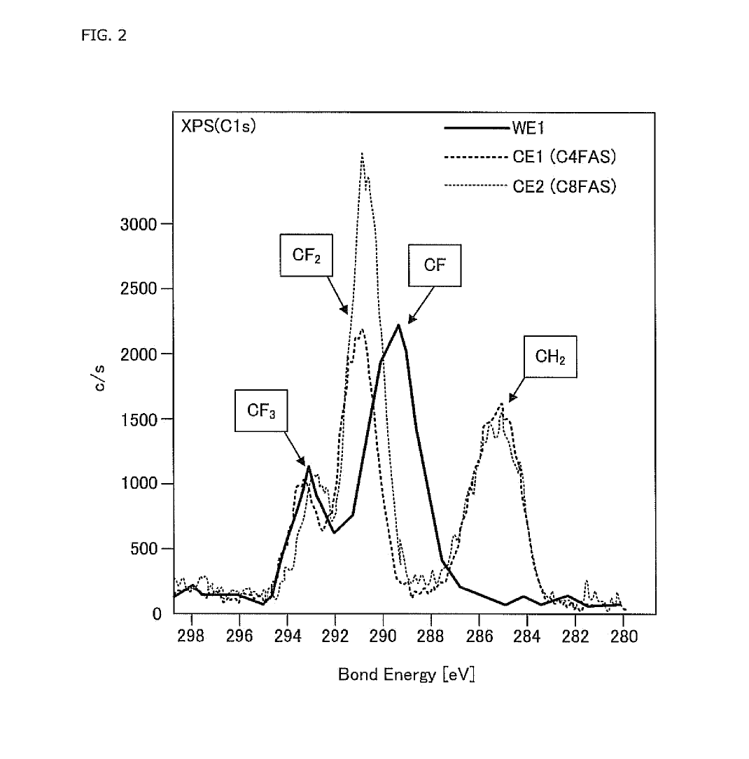

Then, in order to analyze the difference in functional groups which exist on the surfaces of the various coatings concerning Working Example 1 (WE1) and Comparative Examples 1 and 2 (CE1 and CE2), X-ray photoelectron spectroscopy (XPS: X-ray Photoelectron Spectroscopy) on the surface of various coatings was performed. The results of the XPS analysis on the surfaces of the various coatings are shown in FIG. 2. As mentioned previously, FIG. 2 is a X-ray Photoelectron Spectroscopy (XPS) spectrum on the surfaces of a water-repellent and oil-repellent coating of Working Example 1 (WE1) according to one embodiment of the present invention and water-repellent and oil-repellent coatings of Comparative Examples 1 and 2 (CE1 and CE2) according to a conventional technology.

As apparent from the XPS spectrum shown in FIG. 2, in the XPS spectra about the surfaces of the water-repellent and oil-repellent coatings of Comparative Example 1 (dashed line) and Comparative Example 2 (dotted line), peaks corresponding to a methylene (—CH₂—) group, a difluoromethylene (—CF₂—) group, and a trifluoromethyl (—CF₃—) group were observed, respectively. On the contrary, in the XPS spectrum about the surface of the water-repellent and oil-repellent coating of Working Example 1 (solid line), the peaks corresponding to a methylene (—CH₂—) group and a difluoromethylene (—CF₂—) group were not observed, but only the peaks corresponding to a trifluoromethyl (—CF₃—) group and a fluorine atom bonded with an aromatic carbon (CF) were observed.

As mentioned above, from the results of the XPS analysis, it has been that, in the coatings according to Comparative Examples 1 and 2 (CE1 and CE2), the side chain on the siloxane skeleton includes a methylene (—CH₂—) group and a difluoromethylene (—CF₂—) group constituting a factor for presenting relatively high surface energy, whereas, in the coating according to Working Example 1 (WE1), the side chain on the siloxane skeleton does not include such a group presenting relatively high surface energy, but includes only a trifluoromethyl (—CH₃) group and a fluorine atom bonded with an aromatic carbon (CF) constituting a factor for presenting relatively low surface energy.

### 2. Evaluation of Heat Resistance of Water-Repellent and Oil-Repellent Coatings According to Embodiments of the Present Invention

In the present example, heat resistances of water-repellent and oil-repellent coatings according to embodiments of the present invention were evaluated, comparing with Comparative Examples according to a conventional technology. The details of the present example will be mentioned below.

### (1) a Prep of the Sample for a Valuation

Also in the present example, similarly to the previously mentioned example, as substrates, stainless steel plate, aluminum plate, and glass plate were adopted and preliminarily washed by ultrasonic cleaning before forming a water-repellent and an oil-repellent coating thereon, similarly to the previously mentioned example. Various samples for evaluation were prepared by respectively forming various water-repellent and oil-repellent coatings of Working Example 1 (WE1) according to one embodiment of the present invention as well as Comparative Examples 1 and 2 (CE1 and CE2) according to conventional technologies. In addition, in the present example, a sample for evaluation with a water-repellent and the oil-repellent coating of Working Example 2 (WE2) according to another embodiment of the present invention formed on the surface of substrates was also prepared. Therefore, in the description about the present example, only preparation of the sample for evaluation according to Working Example 2 (WE2) will be explained below in detail. In addition, also in the present example, coated film was formed by a dip coating method (dipping method).

Preparation of a sample for evaluation according to Working Example 2 (WE2) will be explained. 23 g of pentafluorophenyl-triethoxysilane (perfluorophenyl-triethoxysilane), 17 g of hydrochloric-acid aqueous solution [0.05 N] and a 39 g of ethanol were mixed and agitated to obtain a solution containing pentafluorophenyl-trisilanol (perfluorophenyl-trisilanol). Into the solution, various above-mentioned substrates were immersed and pulled up to form a coated film consisting of the solution on the surface of various substrates, and heat-treated at 200° C. for 30 minutes to form a coating according to Working Example 2 (WE2).

### (2) Evaluation on Water-Repellency and Oil-Repellency, as Well as Heat-Resistance of Samples for Evaluation

The water-repellency and oil-repellency of the coating formed on the surface of the various substrates of the various samples for evaluation according to Working Examples 1 and 2 (WE1 and WE2) and Comparative Examples 1 and 2 (CE1 and CE2) which were prepared as mentioned above were evaluated. Specifically, similarly to the previously mentioned example, the contact angles to water and oil on the surface of the coating formed on the surface of the various substrates of the various samples for evaluation were measured. In addition, also in the present example, hexadecane was adopted as oil.

Similarly to the previously mentioned example, in all the samples for evaluation according to Working Examples 1 and 2 (WE1 and WE2) and Comparative Examples 1 and 2 (CE1 and CE2), no difference in the contact angles due to the difference in the materials of the substrates (namely, stainless steel plate, aluminum plate, and glass plate) was observed. From this, it can be considered that uniform continuous coating was formed in all the samples for evaluation according to Working Examples 1 and 2 (WE1 and WE2) and Comparative Examples 1 and 2 (CE1 and CE2). Furthermore, in the present example, after holding all the samples for evaluation in an atmosphere at 400° C. for 1 hour, the contact angles to water and oil on the surface of the respective coating were also measured. The measurement results of the contact angles for the various samples for evaluation according to Working Examples 1 and 2 (WE1 and WE2) and Comparative Examples 1 and 2 (CE1 and CE2) are listed in the following Table 3.

TABLE 3

| | | Contact Angle | | Contact Angle | |
|---|---|---|---|---|---|
| | | to Water [°] | | to Oil [°] | |
| | Side Chain on | Before | After | Before | After |
| | Siloxane Skeleton | Heating | Heating | Heating | Heating |
| WE1 | CF₃—C₆F₄— | 127 | 106 | 79 | 64 |
| WE2 | C₆F₅— | 98 | 94 | 59 | 56 |
| CE1 | CF₃—(CF₂)₃—(CH₂)₂— | 109 | 73 | 63 | 26 |
| CE2 | CF₃—(CF₂)₇—(CH₂)₂— | 114 | 76 | 68 | 28 |

As apparent from the evaluation results of the contact angles to water and oil before heating shown in Table 3, Working Example 1 (WE1) according to one embodiment of the present invention presented larger contact angles to both of water and oil, as compared with Comparative Examples 1 and 2 (CE1 and CE2) according to a conventional technology. Namely, it has been confirmed anew that the coating of Working Example 1 (WE1) according to one embodiment of the present invention has higher water-repellency and oil-repellency, as compared with the coatings of Comparative Examples 1 and 2 (CE1 and CE2) according to a conventional technology. On the other hand, Working Example 2 (WE2) according to another embodiment of the present invention presented smaller contact angles to both of water and oil, as compared with Comparative Examples 1 and 2 (CE1 and CE2) according to a conventional technology. Namely, it has been confirmed that the coating of Working Example 2 (WE2) according to another embodiment of the present invention has smaller water-repellency and oil-repellency, as compared with the coatings of Comparative Examples 1 and 2 (CE1 and CE2) according to a conventional technology. However, there are no practical problems with the water-repellency and oil-repellency of the coating of Working Example 2 (WE2), although they are somewhat lower than the water-repellency and oil-repellency of the coating of Comparative Examples 1 and 2 (CE1 and CE2) as mentioned above.

As the reason why the coating of Working Example 1 (WE1) according to one embodiment of the present invention presented higher water-repellency and oil-repellency than the coatings of Comparative Examples 1 and 2 (CE1 and CE2) according to a conventional technology as mentioned above, as mentioned previously, it can be given that, in the coatings according to Comparative Examples 1 and 2 (CE1 and CE2), the side chain on the siloxane skeleton includes a methylene (—CH₂—) group and a difluoromethylene (—CF₂—) group constituting a factor for presenting relatively high surface energy, whereas, in the coating according to Working Example 1 (WE1), the side chain on the siloxane skeleton does not include such a group presenting relatively high surface energy, but includes only a trifluoromethyl (—CH₃) group and a fluorine atom bonded with an aromatic carbon (CF) constituting a factor for presenting relatively low surface energy. In addition, it is believed that the coating according to Working Example 2 does not include a trifluoromethyl (—CF—) group which contributes to present a low surface energy as mentioned previously, but include only a fluorine atom bonded with an aromatic carbon (CF), and therefore it has somewhat lower water-repellency and oil-repellency than those of the coatings of Comparative Examples 1 and 2 (CE1 and CE2).

Furthermore, as apparent from the evaluation results of the contact angles to water and oil after heating shown in Table 3, in Comparative Examples 1 and 2 (CE1 and CE2) according to a conventional technology, the contact angles to both of water and oil decreased largely in association with the above-mentioned heat treatment. On the contrary, in Working Examples 1 and 2 (WE1 and WE2) according to embodiments of the present invention, to both of water and oil, the decrease in contact angles in association with the above-mentioned heat treatment was small and, after the above-mentioned heat treatment, both of Working Examples 1 and 2 (WE1 and WE2) according to embodiments of the present invention maintained larger contact angles as compared with Comparative Examples 1 and 2 (CE1 and CE2) according to a conventional technology. Namely, it has been confirmed that the coatings of Working Examples 1 and 2 (WE1 and WE2) according to embodiments of the present invention have higher thermal resistance as compared with the coatings of Comparative Examples 1 and 2 (CE1 and CE2) according to a conventional technology.

As the reason why the coatings of Working Examples 1 and 2 (WE1 and WE2) according to embodiments of the present invention presented higher heat resistance than the coatings of Comparative Examples 1 and 2 (CE1 and CE2) according to a conventional technology as mentioned above, as mentioned previously, it can be given that, in the coatings according to Comparative Examples 1 and 2 (CE1 and CE2), the side chain on the siloxane skeleton includes a methylene (—CH₂—) group which is relatively easy to be thermally decomposed (pyrolyzed), whereas, in the coating according to Working Examples 1 and 2 (WE1 and WE2), the side chain on the siloxane skeleton does not include such a group which is relatively easy to be thermally decomposed. In addition, in the coatings according to Comparative Examples 1 and 2 (CE1 and CE2), all the carbon atoms bonded with a fluorine atom in a siloxane skeleton are aliphatic carbon atoms, whereas, in the coatings according to Working Examples 1 and 2 (WE1 and WE2), all the carbon atoms bonded with a fluorine atom in a siloxane skeleton, except for carbon atoms included in a trifluoromethyl group included in the coating according to Working Example 1, are aromatic carbon atoms. As mentioned previously, in a bond between an aromatic carbon and a fluorine atom, localization of an electron cloud in a bond between a carbon atom and a fluorine atom (C—F bond) is small. Therefore, a bond between an aromatic carbon atom and a fluorine atom in the coating according to Working Examples 1 and 2 (WE1 and WE2) is chemically more stable, as compared with a bond between an aliphatic carbon atom and a fluorine atom. As a result, it is believed that a bond between an aromatic carbon atom and a fluorine atom (C—F bond) in the coating according to Working Examples 1 and 2 (WE1 and WE2) is less likely to be thermally decomposed (pyrolyzed) and less likely to cause decrease in heat resistance, even in the above-mentioned heat treatment.

As mentioned above, in accordance with a water-repellent and the oil-repellent coating according to the present invention and a formation method of a water-repellent and the oil-repellent coating according to the present invention, a water-repellent and oil-repellent coating which can exert high water-repellency and oil-repellency not only at ordinary temperature, but also even after exposure to a high temperature, and whose environmental burden is low, can be provided.

Although some embodiments with specific configurations have been explained above for the objective of explaining the present invention, it is needless to say that the scope of the present invention is not limited to these exemplary embodiments, various modifications can be properly added thereto within the limits of the matter described in the claims and specification.

What is claimed is:

1. A water-repellent and oil-repellent coating formed on a surface of a substrate,
wherein:
said coating has a siloxane skeleton,
at least one or both of a 4-trifluoromethyl-2,3,5,6-tetrafluorophenyl group and a perfluorophenyl group is bonded with a silicon atom which constitutes said siloxane skeleton, through an aromatic-carbon atom,
a silicon atom which constitutes said siloxane skeleton is bonded with the surface of said substrate through an oxygen atom which does not constitute said siloxane skeleton and wherein the perfluoroalkylaryl group does not include a methylene group, an ether linkage, a carbonyl group, or a difluoromethylene (—CF₂—) group, and
a decreasing rate of a contact angle to water on the surface of said water-repellent and oil-repellent coating is 16.5% or less and a decreasing rate of a contact angle to hexadecane on the surface of said water-repellent and oil-repellent coating is 19.0% or less, when holding said water-repellent and oil-repellent coating in an atmosphere at 400° C. for 1 hour.

2. A formation method of a water-repellent and oil-repellent coating formed on a surface of a substrate,
wherein:
said coating has a siloxane skeleton,
at least one or both of a 4-trifluoromethyl-2,3,5,6-tetrafluorophenyl group and a perfluorophenyl group is bonded with a silicon atom which constitutes said siloxane skeleton, through an aromatic-carbon atom,
a silicon atom which constitutes said siloxane skeleton is bonded with the surface of said substrate through an oxygen atom which does not constitute said siloxane skeleton, and
a decreasing rate of a contact angle to water on the surface of said water-repellent and oil-repellent coating is 16.5% or less and a decreasing rate of a contact angle to hexadecane on the surface of said water-repellent and oil-repellent coating is 19.0% or less, when holding said water-repellent and oil-repellent coating in an atmosphere at 400° C. for 1 hour,
which includes:
hydrolyzing at least one or both of a precursor of 4-trifluoromethyl-2,3,5,6-tetrafluorophenyl trisilanol and a precursor of perfluorophenyl trisilanol,
coating a solution comprising at least one or both of 4-trifluoromethyl-2,3,5,6-tetrafluorophenyl trisilanol and perfluorophenyl trisilanol obtained by said hydrolysis of said precursor, on the surface of said substrate, and
by a dehydration condensation reaction of said silanol, forming said siloxane skeleton, as well as bonding a silicon atom which constitutes said siloxane skeleton with the surface of said substrate through an oxygen atom which does not constitute said siloxane skeleton and wherein the perfluoroalkylaryl group does not include a methylene group, an ether linkage, a carbonyl group, or a difluoromethylene (—CF₂—) group.

3. The formation method of a water-repellent and oil-repellent coating according to claim 2, wherein:
said precursor of 4-trifluoromethyl-2,3,5,6-tetrafluorophenyl trisilanol comprises at least one or more of 4-trifluoromethyl-2,3,5,6-tetrafluorophenyl-trialkoxysilane, 4-trifluoromethyl-2,3,5,6-tetrafluorophenyl-silane trihalide and 4-trifluoromethyl-2,3,5,6-tetrafluorophenyl-triaminosilane, and
said precursor of perfluorophenyl trisilanol comprises at least one or more of perfluorophenyl-trialkoxysilane, perfluorophenyl-silane trihalide and perfluorophenyl-triaminosilane.

4. The formation method of a water-repellent and oil-repellent coating according to claim 2, wherein:
said dehydration condensation reaction of said silanol is initiated with heating.
